(19) United States
(12) Patent Application Publication
(10) Pub. No.: US 2010/0157009 A1
(43) Pub. Date: Jun. 24, 2010

(54) Methods and Systems For Decorating Flexible Packaging

(75) Inventors: Linfang Zhu, Naperville, IL (US); Sumana Sharmin, Schaumburg, IL (US); John Folkers, Palatine, IL (US)

Correspondence Address: Danaher Product ID, 1500 Mittel Blvd, Wood Dale, IL, 60191, US

(73) Assignee: VIDEOJET TECHNOLOGIES, INC., Wood Dale, IL (US)

(21) Appl. No.: 12/572,468

(22) Filed: Oct. 2, 2009

Related U.S. Application Data
(60) Provisional application No. 61/102,585, filed on Oct. 3, 2008.

(51) Int. Cl. B41J 2/32; B44C 1/165; B29C 53/04; B44C 1/175

(52) U.S. Cl. 347/171; 156/230; 156/217; 156/237; 156/234

(57) ABSTRACT

Method and systems are provided for decorating product packaging. A substrate suitable for product packaging to a thermal printer, such as a thermal transfer printer. A decoration is selected for printing on the substrate. The thermal printer is operated to print at least a portion of the decoration on the substrate.

### CROSS REFERENCE TO RELATED APPLICATIONS

This application claim priority to U.S. Provisional Application No. 61/102,585 filed Oct. 3, 2008, and incorporated herein by reference in its entirety

### BACKGROUND OF THE INVENTION

The present disclosure relates to the use of thermal printers for product decoration.

There are two main types of thermal printer. Thermal transfer printers use a heat-sensitive carrier to transfer ink from the carrier to a substrate through pressure and heat to produce an image in the areas where the carrier is treated. Direct thermal printers produce a printed image by selectively heating coated thermochromic paper when the paper passes over the thermal print head. The coating turns black or another color in the areas where it is heated, producing an image.

### BRIEF SUMMARY OF THE INVENTION

As one aspect of the present invention, a method is provided for decorating product packaging. The method comprises feeding a substrate suitable for product packaging to a thermal printer (preferably a thermal transfer printer); selecting a decoration for printing on the substrate; and operating the thermal printer to print at least a portion of the decoration on the substrate.

As another aspect of the present invention, a method is provided for printing a decoration onto a substrate. The method comprises providing a substrate; selecting a decoration; feeding the substrate to a thermal transfer printer having one or more print heads having a plurality of heating elements; providing a first carrier between the print head and the substrate, the first carrier comprising a first color ink releasable from the first carrier upon heating; and operating the thermal printer to urge the carrier against the substrate and selectively energize the heating elements so as to transfer print medium from the carrier to the substrate to print at least a portion of the decoration on the substrate. One or more additional thermal printers can also be used to print a decoration comprising two or more colors.

As yet another aspect of the present invention, a method of decorating product packaging comprises using a thermal transfer printer to print a decoration on a substrate.

As another aspect of the present invention, a system is provided for printing a decoration onto product packaging. The system includes a controller adapted for displaying one or more decorations and for receiving a user's selection of the one or more decorations. The system also includes one or more printers in communication with the controller. At least one of the printers is a thermal printer. The controller is adapted to send control signals to the printer instructing the printer to print at least a portion of the selected one or more decorations.

As another aspect of the present invention, a system is provided for thermal transfer printing a decoration onto a substrate. The system comprises one or more thermal transfer printers. Thermal transfer printers (sometimes referred to as thermal transfer overprinters) typically include a print head having a plurality of heating elements, a roller opposite the print head, a thermal transfer carrier (or ribbon) having an ink, a carrier feed mechanism adapted to feed a carrier between the print head and the roller, and a substrate feed mechanism adapted to feed a substrate between the carrier and the roller. The system can include a first thermal transfer printer having a thermal transfer carrier having a first color ink, and a second thermal transfer printer having a thermal transfer carrier having a second color ink, and additional (third, fourth, etc.) printers and inks as desired. The system also includes a controller in communication with the thermal transfer printer(s) for issuing command signals thereto corresponding to a decoration to be printed.

In the foregoing methods and apparatus, the substrate can be a plastic film, such as a polyvinyl alcohol film. The substrate can be a continuous web comprising a plurality of product packaging units, or the substrate can be a plurality of individual product packaging units. The decoration can printed on each of the product packaging units, either before or after the product packaging units are separated into individual units. The methods and systems can include steps or means for separating the product packaging units, such as by slicing the continuous web into individual units, and forming product packages, such as by folding the units and joining edges of the units to form a bag. The methods and systems can also include steps or means for applying a protective coat to the substrate.

In the present methods and systems, the printer is typically operated by sending one or more control signals from the controller to the printer. The present methods and systems can also include a step or means for displaying the decoration on a controller, or on a user interface in communication with a controller. The controllers used in the present methods and systems may be part of or in communication with a computer, such as a computer having software that allows a user to select, create or modify a decoration and that converts the user-generated decoration into control signals suitable for the thermal printer that instruct the thermal printer to print the decoration or a portion of the decoration. Alternatively or additionally, the controller comprises or is in communication with a touch screen adapted for displaying decoration options and receiving a user's selection of the decoration to be printed on the substrate. The controller can comprise or be in communication with a memory that stores or is capable of storing one or more decorations. Alternatively or additionally, the controller is a computer having a visual display, a user interface, and a memory for storing the data therein, and wherein data corresponding to one or more decorations are stored in the memory such that the stored decoration can be displayed on the visual display and printed onto a substrate by a printer employed by the method or system.

The present methods and systems can also include contacting the substrate with a first carrier comprising a first color ink and a second carrier comprising a second color ink, wherein the second color ink is different than the first color ink. The second color ink can be transferred from the second carrier to the substrate to print a second portion of the decoration, whereby a decoration comprising more than one color is printed on the substrate. The second carrier may be in the same thermal transfer printer as the first carrier, or it may be in a second thermal transfer printer that is in-line with the first.

The present methods and systems can include steps or means for dividing the decoration into first and second decoration portions. For example, a software program may be provided to convert a decoration into one or more decoration portions and/or convert a decoration or portion thereof into control signals for a printer. The present methods and systems can include feeding the substrate to a first thermal printer and operating the first thermal printer to print the first decoration portion; and continuously transferring the substrate from the first thermal printer to the second thermal printer. The present methods and systems can include operating the second thermal printer to print the second decoration portion on the substrate.

The present methods and systems can include viewing multiple decoration options on a display before selecting the decoration. The present methods and systems can also include creating or modifying the decoration via a user interface in communication with the thermal printer. The methods and systems can comprise selecting, creating or modifying the decoration such that the decoration comprises one or more colors.

### DETAILED DESCRIPTION OF THE INVENTION

The methods and systems described in this disclosure employ thermal printers for product decoration. For example, one or more thermal transfer printers are employed to print a decoration on a substrate, such as a flexible plastic film. Thermal transfer printers have been used on flexible plastic films for printing product identification codes, batch codes, and expirations dates. However, it is believed that thermal transfer printers have not been used to print decorations directly onto plastic films. Thermal transfer printers are presently preferred as they can provide the advantages of virtually instant dry time and high resolution with various colors on non-porous substrates such as flexible films.

Product decoration has typically been accomplished through off-line printing processes such as flexographic printing. Web in-line digital printing processes such as thermal transfer overprinting are advantageous over off-line printing processes, but may appear to be uneconomical compared to other printing processes. It is contemplated that thermal printing (particularly thermal transfer printing) offer unrecognized advantages for product decoration of small batches or runs or where a variable decoration is employed, and for inclusion in an in-line printing system. In-line digital printing processes eliminate the need for inventory of pre-printed parts, and provide easy and fast image change, as images can be created or modified with suitable software and stored in a computer. With the ease of selecting a decoration displayed on a computer's video display (for example, by pressing a button on a keyboard or pressing an image of the decoration on a touch screen), a different decoration can be sent via control signals to the printer and be printed on the substrate.

The present disclosure provides in-line printing methods and systems for printing decorations onto non-porous flexible plastic films for product decoration. Off-line printing is a relatively expensive process that requires production lines, production space and inventory management of the printed parts. It is slow and expensive to change the printing image with typical off-line printing processes. In addition, dry time on non-porous plastic films poses a challenge for off-line printing processes due to the need for the carrier of the liquid ink (organic solvents or water) to evaporate quickly. It was discovered that the thermal transfer printing process is very well suited for such applications and overcomes one or more of the difficulties mentioned herein.

The present methods and systems can employ one or more thermal printers. In the following description, thermal transfer printers are frequently used to describe exemplary embodiments, but it is contemplated that the present methods and systems can include direct thermal printers in addition to or in place of the thermal transfer printers in various embodiments described as examples of the present methods and systems.

For purposes of illustration, the structure and operation of a suitable thermal transfer printer is now described, though it is expressly contemplated that other types of thermal printers can be used, and the following description is merely intended as an aid to understanding the present methods and systems and is not to be viewed as limiting in any regard. A typical thermal printer is configured to receive a flexible substrate and to print onto that substrate. The thermal printer typically includes a print roller which, in use, is arranged to support the flexible substrate which is fed over the print roller by a substrate feed mechanism. The print roller may be driven and have a resilient outer surface. However, in other embodiments the print roller may not be driven. A substrate feed mechanism comprises a supply spool and a take-up spool. A flexible substrate is conveyed from the supply spool to the take-up spool by means of rollers.

A typical thermal printer also comprises a print head having a plurality of individually selectable heating elements. The individual heating elements form a linear array which extends in a direction generally transverse to the flexible substrate and parallel to the rotational axis of the print roller. These heating elements are located on the edge of the print head that is closest to the print roller. The print head can include a suitable number of individual heating elements; for example, there may be 12 heating elements per millimeter along the print head edge, or even more. The print head is supported by a print head support assembly, which may include a carriage on which the print head is mounted. The thermal printer typically also includes a controller which is operable to supply control signals to control the print head and to selectively energize the heating elements. Also mounted on the carriage is an actuator which is controllable by the controller to move the print head towards and away from the print roller.

A typical thermal transfer printer also comprises a carrier feed mechanism adapted to feed a flexible carrier between the print head and the substrate. The carrier (sometimes referred to as a ribbon) comprises an ink that is released from the carrier upon heating (when the carrier contacts the selectively heated elements of the print head). A typical carrier feed mechanism comprises a supply spool and a take-up spool. The carrier is conveyed from the supply spool to the take-up spool by means of rollers. During a printing operation, the carrier is in contact with and passes over the edge of the print head which comprises the heating elements, and also contacts the substrate. The carrier then passes over the roller which is mounted on the carriage.

The thermal transfer printer is operable (such as by control signals from the controller) to cause the print head to be urged towards the print roller, so as to urge the print head against the carrier, the carrier against the substrate, and the substrate against the backing roller. The controller, in use, is arranged to receive image data and controls the printing of images on the flexible substrate.

Thermal transfer printers can be designed for operation in one or both of two different types of thermal printing processes: continuous and intermittent. In continuous-type thermal transfer printers, the print head is stationary and the substrate to be printed is moving during printing. The ribbon is driven, usually, but not always, at the same speed as the substrate and the print head is pressed against a print roller with the ribbon and substrate sandwiched in-between so as to transfer an image onto the substrate. In intermittent-type thermal printers, during printing the print head is moved against a flat print platen with the ribbon and substrate stationary in-between in order to transfer a print image.

During continuous printing the print head is located with the edge carrying the heating elements pressing down on the crown of the roller. In contrast, during incremental printing the print head can be moved to a start position on the roller surface and then moved through an arcuate path ending at end position on the roller surface. While this arcuate movement is being performed, the heating elements of the print head are being selectively energized to print an image portion on the substrate.

The typical thermal printer prints an image on a substrate by printing one or more portions of the image sequentially. A single image may be built up (printed) from a series of printed portions, at least some of which may overlap. This may also be implemented by dividing the image up into a series of image portions, at least some of which overlap. Thus, when two portions overlap, they will of course have some of the complete image in common.

Additional details and embodiments of thermal printers can be found in the published literature, for example, in McNestry et al. US Patent Application Pub. No. 2007/0252888; and Kapushinski et al. US Patent Application Pub. No. 2002/0057325. An example of a thermal transfer printer for use in the present systems and methods is the Videojet DataFlex Plus print available from Videojet Technologies, Inc. of Wood Dale, Ill. As mentioned above, it is contemplated that the present methods and systems can include other thermal printers in various embodiments described as examples of the present methods and systems. For example, the thermal printer may be a multicolor thermal ribbon transfer printer, and additional details and embodiments of a multicolor thermal ribbon transfer printer, ribbon and media can be found in the published literature, for example, in Braun et al. US Patent Application Pub. No. 2008/0079798.

The present methods and systems may comprise one or more thermal transfer printers in communication with the controller. If two or more printers are employed, each of the thermal transfer printers can have a carrier having a different color ink than any other of the thermal transfer printers. Where two or more printers are employed, they can be the same type of printer, but loaded with different carriers (such as carriers having different color inks), or they can be different types of printers.

The present methods and systems are useful for printing one or more decorations on a substrate. The present methods and systems can include providing control signals to one or more thermal printers (or other printers), whereby the control signals instruct the printer(s) to print a decoration or a portion thereof. The present methods and systems can include a plurality of thermal printers, each of which is loaded with a carrier having an ink of different color. A decoration comprising two or more colors can be printed on a substrate by instructing a first thermal printer to print a first color portion of the decoration, and instructing a second thermal printer to print a second color portion of the decoration. The first color portion and the second color portion may overlap to provide one or more colors distinct from the nominal colors. The first color, second color and additional colors can be selected from colors such as white, black, blue, dark blue, green, red, yellow, magenta, cyan, orange, brown or another color, or combinations or mixtures of those colors or others.

The present methods and systems are useful for printing a decoration on a suitable substrate. Suitable substrates include flexible plastic films, including porous and non-porous films. The plastic films may be water-soluble or water-insoluble. Suitable water soluble films include polyvinyl alcohol, polyvinylpyrrolidone, carboxymethylcellulose, polymers (homopolymers and copolymers) based on acrylic acid, polymers (homopolymers and copolymers) based on methacrylic acid, and polymers (homopolymers and copolymers) based on acrylamide, and any combination thereof, and gelatin. The substrate may be a part of a consumer product, such as dishwasher soap tablets or pouches and pharmaceutical capsules. The water-insoluble films include polyester, polyethylene, polypropylene, polycarbonate, other known polyolefins, acrylic acid/polyethylene copolymers, polyethylene terephthalate, laminated paper substrates, and suitable substrates may include combinations of the foregoing materials. Suitable substrates may also include those useful for flexible packaging for foods, toys, and the like. The substrates may be multilayered laminates or individual layers to be later laminated to other layers.

Thermal transfer ribbons or other carriers can be selected based upon the thermal printer to be used and the colors of the decorations to be printed. Examples of thermal transfer ribbons for use in embodiments of the present method and systems include the following ribbons available from Videojet Technologies Inc. of Wood Dale, Ill.: 15-S110KQ5 (black); 15-S20KQ25 (black); 15-S30KQ25 (black); 15-S30KQ25-600 (black); 15-S55KQ10 (black); 15-S55KQ10-600 (black); 15-S30YQ25 (yellow); 15-S55YQ10 (yellow); 15-S55MQ10 (magenta); 15-S55CQ10 (cyan); 15-S55OQ10 (orange); 15-S55NQ10 (brown); 15-S55RQ10 (red); 15-S55GQ10 (green); 15-S30LQ25 (blue); 15-S55LQ10 (blue); 15-S110WQ5 (white); 15-S20WQ25 (white); 15-S30WQ25 (white); 15-S30WQ25-600 (white); 15-S55WQ10 (white); 15-S55WQ10-600 (white); 15-P55KQ10 (black); 15-P55WQ10 (white); 15-H30KQ25 (black); 15-H55KQ1 (black); 15-R110KQ5 (black); 15-R20KQ25 (black); 15-R30KQ25 (black); 15-R55KQ10 (black); 15-R55LQ10 (dark blue); 15-R55GQ10 (green); 15-R55RQ10 (red); 15-R110WQ5 (white); 15-R30WQ25 (white); 15-R55WQ10 (white); 15-X55KQ10 (black); and 15-X110KQ5 (black). Other thermal transfer ribbons and techniques for generating various colors are discussed in the published literature, including Geddes et al. U.S. Pat. No. 7,374,801 and Gerber U.S. Pat. No. 6,002,416.

A decoration printed using the present methods or systems may, for example, comprise or consist of one or more of the following: a figure; a picture; an artistic work; a graphic work; a photograph; a piece of intelligible text; a representation of a design; or a logo. Generally, a decoration is something other than an identification code, batch code, bar code, or expiration date, though a decoration may be configured around or cooperate with such codes or dates. Decorations are generally ornamental or artistic. It will be appreciated that this list is not exhaustive, and other forms of decoration may readily be printed using embodiments of the present methods and apparatus. Decorations for a small number of packages or for a limited time are contemplated as especially suitable for the present methods and systems. For example, holiday decorations, promotional decorations, or contest decorations may be printed in an efficient and economical manner by use of the present methods and systems.

The present methods and systems may employ a computer as a controller for one or more printers, or in communication with a separate controller. A computer (as used herein) includes any micro-processor or computing device capable of performing one or more of the functions described herein. The computer may be any suitable computer including a personal computer, a mainframe computer, or a system of networked computers. The computer preferably includes a processor for executing instructions and a memory for storing instructions, such as instructions for operating a thermal printer in response to control signals from the computer or other controller. More preferably, the computer includes a memory having instructions for operating one or more thermal printers in sequence, such that the thermal printer(s) operate to print a decoration on a substrate passing through the two or more thermal printers. The memory can be a hard drive of the computer, or one or more disks, or a remote computer or server in communication with the first computer. The memory may be any suitable computing memory device, which may but need not be removable. Other suitable examples include random access memory (RAM), read only memory (ROM), video memory card such as Video Random Access memory (VRAM), flash memory, and/or any suitable removable recording media such as a floppy disk, a compact disk (CD), a digital video disk (DVD), or a thumb drive, flash drive or memory stick.

The present methods and systems optionally may comprise one or more computers in communication with one or more thermal printers. A computer may be used as the controller of the printer and may provide control signals to the printer. The components of the present methods and systems (such as the printers, controllers, feed mechanisms, in-line process equipment and other components) may be adapted for communication with each other by any suitable communication medium, standard, protocol or network such as a hardwire, a radio frequency signal, or a light signal. Some illustrative mediums, standards, protocols or networks include without limitation, hardwire, Universal Serial Bus (USB), FireWire, i.Link, IEEE 1394, ethernet, cable modem, broadband DSL, the Internet, the Public Switched Telephone Network (PSTN), intranets, Local Area Networks (LAN), Wide Area Networks (WAN), Wireless Area Network or Wireless Local Area Network (WLAN) or any other suitable communication standard, system, standard or protocol such as any Wireless Fidelity (Wi-Fi) system or network, including 802.11a, 802.11b, and 802.11g Wi-Fi systems, bluetooth systems, infrared systems, and the like.

The computer may run any suitable software including commercially available, proprietary or open source software. For example, the computer may run Windows-based software, Macintosh-based software UNIX-based software, Linux-based software or other software.

The present methods and systems can include one or more programs or software for generating or manipulating visual images or graphics on a computer. For example, a computer employed in the present systems can have graphic art software stored in its memory. Graphic art software is used for graphic design, multimedia development, specialized image development, general image editing, or simply to access graphic files. The programs or software can be capable of generating raster graphics, vector graphics, or a combination of those. The graphic art software can be employed by a user to create or modify a decoration to be printed on a substrate according to the present methods or systems.

The present methods and systems can include a suitable user interface, as part of a controller or in communication with a controller. The user input device can be a keyboard, mouse, microphone, touchpad, or other computer peripheral. The user input can be combined with a video display; for example, a touchscreen may be employed to receive input and to display options and decorations.

A decoration can be digitally created and stored in a memory of the computer. The computer can include software that allows a user to create a decoration and that converts the user-generated decoration into control signals suitable for the thermal printer that instruct the thermal printer to print the decoration or a portion of the decoration. Alternatively a pre-existing decoration can be scanned or otherwise converted into a digital representation, and inputted to a computer. The computer can be used to process the digital representation into a plurality of portions of the original decoration. The various portions can be substantially separate from each other or may overlap to any desired degree. In addition to selecting the appropriate design and colors, the computer (or data or software stored on the computer or a memory) can also determine the optimal combination of color ribbons or carriers for printing the decoration.

The present methods and systems can include a coating apparatus that applies a protective coat to the decorated substrate. Preferably the protective coat is a clear coat that provides protection from chemical and/or physical damage, such as water damage or scratching. The protective coat can be applied by any method known in the art (such as flexography, screen-printing, offset, gravure, Meyer rod). The protective coat can be radiation curable, and more preferably, ultraviolet light curable. The protective coat can comprise a cross-linkable clear coat.

### Example 1

In this example, a thermal transfer printer was used to print a variety of colors on substrates. Examples for 4 colors of thermal transfer ribbons, namely, 15-S55KQ10, black; 15-S55RQ10, red; 15-S55BQ10, blue, and 15-S55GQ10, green were loaded sequentially onto a thermal transfer printer, namely a Videojet DataFlex 53. Polyvinyl alcohol film was passed through the thermal transfer printer, and the color printing on the polyvinyl alcohol film was evaluated. All 4 color inks were printed on the substrate and showed excellent adhesion, print quality, contrast, and dry time of less than 1 second.

TABLE 1

| | | Print | | Dry | |
|---|---|---|---|---|---|
| | Adhesion | Quality | Contrast | Time | Printer |
| 15-S55KQ10 | Excellent | Excellent | Excellent | <1 sec | DataFlex 53 |
| 15-S55RQ10 | Excellent | Excellent | Excellent | <1 sec | DataFlex 53 |
| 15-S55BQ10 | Excellent | Excellent | Excellent | <1 sec | DataFlex 53 |
| 15- | Excellent | Excellent | Excellent | <1 sec | DataFlex 53 |
| S55GQ10 | | | | | |

This example demonstrates that a thermal transfer printer can be employed to print various colors onto a non-porous flexible film suitable for product packaging.

### Example 2

In this example, a thermal transfer printer is used to print a seasonal decoration on packaging for a consumer product. A thermal transfer printer has a ribbon cartridge having white ink. A polyvinyl alcohol film is passed as a continuous web through the printer, which prints white snowflakes as a winter decoration on the film. The film is then separated into individual product packaging units.

### Example 3

In this example, a thermal transfer printer is used to print a Christmas decoration on packaging for a foodstuff. Two thermal transfer printers are provided in sequence. The first thermal transfer printer has a ribbon cartridge having green ink, and the second thermal transfer printer has a ribbon cartridge having red ink. A polyvinyl alcohol film is passed through the thermal transfer printers, and the first printer prints a green tree, and the second printer prints a red bow around the tree, thereby creating a Christmas tree decoration on the substrate.

In the present specification, use of the singular includes the plural except where specifically indicated. The terms “including” and “having” are used as open-ended terms and mean the same as “comprising.” In the present specification, any of the functions recited herein may be performed by one or more means for performing such functions. The present systems and methods may include various means, modules, code segments, computer programs and/or software for performing one or more of the steps or actions described in this specification. It is expressly contemplated and disclosed that the present specification provides a written description for claims comprising such means, modules, code segments, computer programs and/or software.

All of the references cited herein, including patents, patent applications, and publications, are hereby incorporated in their entireties by reference.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Although the dependent claims have single dependencies in accordance with U.S. patent practice, each of the features in any of the dependent claims can be combined with each of the features of other independent or dependent claims.

1. A method of decorating product packaging, the method comprising:
feeding a substrate suitable for product packaging to a thermal transfer printer, wherein the substrate is a water soluble plastic film;
selecting a decoration for printing on the substrate; and
operating the thermal printer to print at least a portion of the decoration on the substrate.

2. The method of claim 1, wherein the water soluble film comprises polyvinyl alcohol.

2. The method of claim 1, further comprising displaying the decoration on a controller, or on a user interface in communication with a controller, and the printer is operated by sending one or more control signals from the controller to the printer.

3. The method of claim 1, wherein the substrate comprises a continuous web comprising a plurality of product packaging units, and the decoration is printed on each of the product packaging units.

4. The method of claim 3, wherein the substrate comprises a plurality of individual product packaging units.

5. The method of claim 3, further comprising the steps of separating the product packaging units, such as by slicing the continuous web into individual units, and forming product packages, such as by folding the units and joining edges of the units to form a bag.

6. The method of claim 1, further comprising the step of applying a protective coat to the substrate.

7. A method of printing a decoration onto a substrate, the method comprising:
providing a substrate, wherein the substrate is a water soluble plastic film;
selecting a decoration;
feeding the substrate to a thermal transfer printer having one or more print heads having a plurality of heating elements;
providing a first carrier between the print head and the substrate, the first carrier comprising a first color ink releasable from the first carrier upon heating; and
operating the thermal printer to urge the carrier against the substrate and selectively energize the heating elements so as to transfer print medium from the carrier to the substrate to print at least a portion of the decoration on the substrate.

8. The method of claim 7, wherein the substrate is a polyvinyl alcohol film.

9. The method of claim 7, further comprising the step of contacting the substrate with a second carrier, the second carrier comprising a second color ink releasable from the second carrier upon heating; and transferring the second color ink from the second carrier to the substrate to print a second portion of the decoration; whereby a decoration comprising more than one color is printed on the substrate.

10. The method of claim 9, wherein the second carrier is urged against the substrate by a second thermal printer.

11. The method of claim 7 wherein the method comprises
dividing the decoration into first and second color portions;
feeding the substrate to a first thermal printer and operating the first thermal printer to print the first color portion;
continuously transferring the substrate from the first thermal printer to the second thermal printer; and
operating the second thermal printer to print the second color portion on the substrate.

12. The method of claim 7 further comprising viewing multiple decoration options on a display before selecting the decoration.

13. The method of claim 7 further comprising creating or modifying the decoration via a user interface in communication with the thermal printer.

14. The method of claim 7 further comprising selecting, creating or modifying the decoration such that the decoration comprises at least two colors.

15. A system for thermal transfer printing a decoration onto a substrate comprising:
a first thermal transfer printer comprising a print head having a plurality of heating elements, a roller opposite the print head, a thermal transfer carrier having a first color ink, a carrier feed mechanism adapted to feed the carrier between the print head and the roller, and a substrate feed mechanism adapted to feed a substrate between the carrier and the roller; and
a controller in communication with the thermal transfer printer for issuing command signals thereto corresponding to a decoration to be printed.

16. The system of claim 15, further comprising a second thermal printer in communication with the controller, wherein the first and second thermal printers comprise carriers having inks of different colors.

17. The system of claim 15, wherein the controller comprises or is in communication with a touch screen adapted for displaying decoration options and receiving a user's selection of the decoration to be printed on the substrate.

18. The system of claim 15, wherein the controller is a computer having a visual display, a user interface, and a memory for storing the data therein, and wherein data corresponding to one or more decorations are stored in the memory such that the stored decoration can be displayed on the visual display and printed onto a substrate by the thermal transfer printer.

19. The system of claim 15, wherein the controller comprises or is in communication with a touch screen adapted for displaying decoration options and receiving a user's selection of the decoration to be printed on the substrate.

20. The system of claim 15, wherein the controller comprises or is in communication with a memory that stores or is capable of storing one or more decorations.
